(19) United States
(12) Patent Application Publication
(10) Pub. No.: US 2008/0255956 A1
(43) Pub. Date: Oct. 16, 2008

(54) System and Method for Creating Personal Websites

(75) Inventors: Erik Berglund, Linkoping (SE); Magnus Bang, Linkoping (SE); Anders Larsson, Linkoping (SE)

Correspondence Address: VENABLE LLP, P.O. BOX 34385, WASHINGTON, DC, 20043-9998, US

(73) Assignee: OMNITUS AB, Linkoping (SE)

(21) Appl. No.: 11/795,767

(22) PCT Filed: Jan. 17, 2006
(86) PCT No.: PCT/SE2006/000064

§ 371 Date: Jul. 20, 2007

(30) Foreign Application Priority Data
Jan. 20, 2005 (SE) 0500139-1

(51) Int. Cl. G06Q 30/00; G06Q 99/00

(52) U.S. Cl. 705/26; 705/1

(57) ABSTRACT

A system and a method for creating a personal website in a public website on the Internet. At least one RFID transponder is intended to be placed at a physical sales meeting premise. A website configuration system includes an element to create the personal website in the public website on the Internet. At least one portable unit includes an RFID reader and an element for wirelessly communicating data to the website configuration system. Each portable unit is arranged to send data, which via its RFID reader has been read from at least one RFID transponder, to the website configuration system, which is arranged to create the personal website in the public website on the Internet based on said data.

### TECHNICAL FIELD

The present patent application relates to a system for creating a personal website in a public website on the Internet in accordance with the preamble of claim 1.

### BACKGROUND OF THE INVENTION

The web, or the Internet, is a source of information for customers, which next to a shop functions as a place of information for making purchase decisions but also as place of purchase. To be able to give a customer a personal website is a way to guide the customer, but also a way to funnel the customer to the sales organizations own web material, and thus reduce the risk of a deal, which has been initiated in a specific shop, going to a competitor or failing due to confusion.

Today, the web is often perceived as a threat to in-shop sales. Often a sale is initiated in a specific shop but later performed at the web, possibly with a competitor or at the central organization, without connection to the specific shop where the sale was initiated.

Today, there is limited support, which with sufficient flexibility supports the sales meeting, in order to easily document a sales meeting in a shop. Today, procurement of contact information to customers does not take place as an equal trade-off and thereby threatens to make the customer feel uncomfortable. As a result sales meetings often remain undocumented, and in particular with respect to the contact information of the customer.

Basically, it is a very difficult task, using known systems, to document a sales meeting in a shop. The shop environment puts high demands on salespersons/hosts, because new customers constantly enter. The space for sitting down and compiling documentation is highly limited, possibly even non-existent. Furthermore, man to its nature is not a being having an unlimited memory capacity. It is hard for us to remember more than a few things clearly, and we may mix things up after a while.

Systems which directly support documentation of customer visits in shops have up until now been based upon compilation of product codes, which have been scanned from barcodes in a shop. Through these systems the salesperson or the customer may build a list of products to a customer's wish list. A previously known system for building wish lists by registering product codes is described in the patent application “INTERACTIVE IN-STORE/IN-MALL AND ONLINE SHOPPING SYSTEM AND METHOD” WO 0135186. The association between the interests of the customer and products is here done outside of the system. In WO 0135186 is also described how a customer's wish list may be assembled through product codes being scanned during the customers visit in a shop.

The previously known system, according to WO 0135186, is not able to differentiate in which shop the product code was read. Soft data, which describe the preferences of the customer, for example that the customer is interested in safety, is not handled by this and other similar systems. Furthermore, the system does not make it natural for the customer to give away his/her contact information, such that the salespersons get access thereto.

### SUMMARY OF THE INVENTION

One object of the invention is to provide an improved system for creating a personal website in a public website on the Internet, through which the problems and drawbacks described above are eliminated or at least reduced.

In one embodiment of the present invention this object is achieved in accordance with the system described in claim 1.

Thanks to the provision of a system which comprises: at least one RFID transponder, intended to be placed at a physical sales meeting premise; a web site configuration system, having means for creating the personal website in the public website on the Internet; at least one portable unit, comprising an RFID reader and means for wirelessly communicating data to said website configuration system; where said at least one portable unit is arranged to send data, which via its RFID reader has been read from said at least one RFID transponder, to said website configuration system, which is arranged to create said personal website in said public website on the Internet based on said data, a system is created which enables the creation of a personal website in a public website on the Internet which is part of a physical sales meeting premise or shop, and which is also a tool for in-shop sales.

A further object of the invention is to provide an improved method for creating a personal website in a public website on the Internet, through which the problems and drawbacks described above are eliminated or at least reduced.

In one embodiment of the present invention this object is achieved in accordance with the method described in claim 6.

Thanks to the provision of a method which includes the steps of: placing at least one RFID transponder at a physical sales meeting premise; providing a website configuration system, with means for creating the personal website in the public website on the Internet; providing at least one portable unit, comprising an RFID reader and means for wirelessly communicating data to said website configuration system; reading data from said at least one RFID transponder to said at least one portable unit via its RFID reader; where said at least one portable unit is arranged to sand data, which have been read from said at least one RFID transponder, to said website configuration system, which is arranged to create said personal website in said public website on the Internet based on said data, a method is provided which enables the creation of a personal website in a public website on the Internet which is part of a physical sales meeting premise or shop, and which also is a tool for in-shop sales.

Preferred embodiments are presented in the dependent claims.

### DESCRIPTION OF THE DRAWINGS

In the following the invention will be described in greater detail with reference to the attached drawings, in which:

FIG. 1 shows schematically a structure of the system in accordance with the present invention according to a first embodiment.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein

### DESCRIPTION OF EMBODIMENTS

This invention relates to a system for, in conjunction with a visit at a physical sales meeting premise 2 or shop, being able to provide a customer with a personal website 4, which compiles information from the sales meeting and concerns the products, offers, services, customer profiles and so on which the customer is interested in. The information in this way is presented in an accessible format, whereby the web becomes a part of the sales tools of the shop.

The personal website 4 is built such that it is perceived as relevant for the customer and makes it simple to find the right things quickly and easily, such that work done at the shop not has been done in vain. The customer web 4 is built during a visit at the physical sales meeting premise 2 or shop and is created in close relation to the visit. The customer who visits the personal website 4 shall recognize him/her self, and decisions regarding interests and choices made at the shop are accessible as a part of the website, such that it is part of the sales tools of the shop.

The inventive system for creating a personal website 4 during a customer visit at a shop 2 is driven by the salesperson/customer making active choices of what they want to bring along to the personal customer web 4 and that they with their eyes see the chosen components at the shop. Hereby, the system has the ability to create a personal website 4, which has high precision accuracy in relation to the desires of the customer.

An important factor for, in a functioning way, creating a personal website 4 during a customer visit in a shop 2, using the inventive system, is that the salesperson using his/her eyesight, as described above, can see the parts of the generation process of the personal website 4. Systems which do not benefit from eyesight do not have the same ability to function, because eyesight is the most important human sense and it is known that humans are associative and that our memories and mental processes are strongly influenced or controlled by visual signals.

Through making the salesperson and the shop 2, which the customer has visited, a part of the personal website 4, such that the personal website 4 is a part of the business transaction at the shop 2 and a tool for in-shop sales, the relationship to the salesperson and the shop 2 which the customer visits is woven into the personal website 4. In conjunction with the construction of a personal website 4 also other subjects than products and product offerings may be introduced.

In accordance with the invention here described it is possible to build a more general website generation process, which handles both hard product preferences and soft values, and which can join in the shop 2 and the salesperson as a part of the website 4. In one embodiment the matching to offers may be made after the visit, as an analysis of values input, and thereby ensure that the correct offers are presented to the customer. The customer may also be given exactly the correct e-documents at the website 4 for closing the business transaction and/or for enabling the salesperson to do so at the shop. As an example, the salesperson may give the husband a safety pamphlet for a car model in order for him to show the wife at home in the evening, alternatively send along a current offer.

The inventive system displays a natural integration with sales meetings in the shop environment, regarding relief, automatic data gathering and simple compilation of materials on the Internet 6. In accordance with the invention here presented there is provided a system which enables a sales meeting technique where the creation of a personal website 4 becomes a natural part of the meeting, without disturbing the customer and the salesperson.

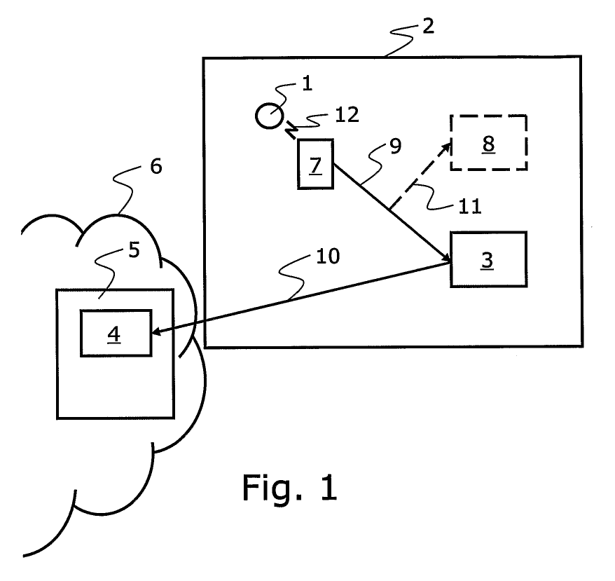

FIG. 1 illustrates schematically a structure of the inventive system for creating a personal website 4 in a public website 5 on the Internet 6 according to a first embodiment. The system comprises at least one RFID (Radio Frequency Identification) transponder 1, which is intended to be placed at a physical sales meeting premise 2. Further, the system comprises a website configuration system 3, having means (schematically illustrated by the arrow 10) for creating the personal website 4 in the public website 5 on the Internet 6. As the structure of such a website configuration system 3 may be considered as evident to the person skilled in the art, this will not be described in further detail in the following. In the system at least one portable unit 7 comprises an RFID reader (schematically illustrated by the arrow 12) and means (schematically illustrated by the arrow 9) for wirelessly communicating data to the website configuration system 3. The portable unit(s) 7 is/are arranged to send data, which via their RFID reader 12 has been read from at least one RFID transponder 1, to the website configuration system 3. The website configuration system 3 is arranged to create the personal website 4 in the public website 5 on the Internet 6 based on these data, in an as described above previously known manner.

Each RFID transponder 1 may be enclosed and completely concealed inside an arbitrary physical shape, such as a plastic article, a paper, a shop display stand or a painting or poster or be embedded in a product or a label of a product or other similar physical shape. An RFID transponder 1 is an electronic circuit having a potentially globally unique serial number, for identification, and having a readable and potentially writeable memory, for data storage. The RFID transponder 1 may be read wirelessly, from varying distances, using an RFID reader 12, and then emit its serial number and/or data.

The RFID transponder 1 is intended to be placed at a physical sales meeting premise 2. A sales meeting premise is a place where a customer (human) meets a salesperson (human) and discusses a future business transaction, which may take place during the meeting at site, at a later time or at another location. Examples of physical sales meeting premises are shops, show-rooms, demonstration halls, exhibition stands, the entrance hall of a business, meeting rooms and to a certain extent meeting sections in offices etc. Some premises have both divisions for sales meeting premises and other divisions where sales meetings with customers do not occur.

The website configuration system 3 is suitably arranged in the portable unit 7 with RFID reader 12, or at an own location in a computer network, as an Intranet or Internet 6 or as part of a website on the Internet 6. The website configuration system 3 may be a computer program, a document or a program accessible via a web server, an HTML (HyperText Markup Language) page, an XML (Extensible Markup Language) page, a search engine on Internet, a so called web service, an ASP page, a JSP page, a PHP page, an ASPX page, a database, or document or computer program accessible via TCP/IP or UDP or other similar system etc. The website configuration system 3 compiles electronic resources based on different data, such as texts, images, movies, sounds, documents, programs and web addresses such as URLs or URIs, and these may represent different for the customer relevant data such as product pamphlets, brochures, offers, quotations, specifications, interest associations on the Internet, computer programs, addresses etc. The personal website 4 is personal through its content by a customer being considered to reflect what the customer was studying or was interested in during one or a series of visits, which may also be data which by derivation from visits may be considered relevant for visits, without explicitly having been mentioned or been caught on to during the visit. The personal website 4 is part of a public website 5 on the Internet 6, a to the sales person clearly and concisely associated website 5, which the customer identifies as the website 5 of the organization, or alternatively an associated site having a clear connection to the sales person, such as an interest organization or a club on the Internet 6 etc.

Each of the portable units 7 has, as mentioned above, RFID readers 12 and means 9 for wirelessly communicating data to the website configuration system 3. Such a portable unit 7 may be a mobile phone having an integrated RFID reader, a portable computer having an integrated RFID reader, a portable wireless RFID reader, which sends its signal directly to the computer network, a portable slave-screen or terminal-computer having a physically attached or an integrated RFID reader, and a wireless computer network or other similar hardware. The wireless computer network may be a radio network, such as a WLAN (Wireless Local Area Network), a Bluetooth network (Bluetooth®), a mobile phone network, such as GSM (Global System for Mobile Communications), GPRS (General Packet Radio Service), 3G (Third Generation), sound and light networks, such as IR (Infra Red) based networks, e.g. according to the IrDA® (Infrared Data Association) standard, and other similar networks for data communication. The computer network may be local at the sales meeting premise 2, connected to the Intranet of an organization, or to the Internet 6.

The system is arranged such that the portable units 7 send data, which has been read from the RFID transponders 1. The portable units 7 further comprises, as mentioned above, means 9 for wirelessly communicating data to the website configuration system 3. The website configuration system 3 is, as mentioned earlier, arranged to create the personal website 4 in the public website 5 on the Internet 6. A portable unit 7, with an RFID reader 12, is brought into proximity of one or more RFID transponders 1 and reads data from these. Data read from the RFID transponders 1 may be the serial number of the respective RFID transponder or data stored in a memory of each RFID transponder 1, which data are sent to the website configuration system 3.

In an additional embodiment the inventive system includes multimedia units 8, which are intended to be placed at the physical sales meeting premise 2. The multimedia units 8 comprises means (schematically illustrated by the arrow 11) for receiving to the website configuration system 3 wirelessly communicated data and means (not shown) for presenting multimedia based on these data.

Multimedia units 8 are units which are able to display digital media, such as text, images, sounds and movies. Examples of multimedia units are computers having connected touch screens, large size screens, projectors, Plasma TV devices, LCD screens, or other similar units, and portable computers having screens, such as laptop computers, TabletPC devices, handheld computers, mobile phones, or similar portable units or a computer having a portable slave-screen or other similar units for audio reproduction, such as loudspeakers.

Each multimedia unit 8 has means (not shown) for controlling a multimedia presentation based on data via presentation systems, such as Microsoft® PowerPoint®, Macromedia® Flash® player, web browser systems such as Microsoft® Internet Explorer®, Mozilla®, or Adobe® Acrobat® or other similar presentation systems. The multimedia units 8 further have means 11 for receiving data, which have been read from RFID transponders 1 and sent with the previously mentioned means 9 for communicating on wireless computer networks by the portable units 7 with RFID readers 12. Means for receiving data are provided through the multimedia units 8 having means for monitoring data communications sent with the means 9 for communicating via wireless computer networks or that the website configuration system 3 and/or the portable units 7 with RFID readers 12 are arranged such that they also send read data to the multimedia units 8.

In yet another embodiment of the system at least one portable unit 7 is a mobile phone, a handheld computer or a portable display equipped computer having a physically connected or integrated RFID reader.

In a further embodiment of the system the personal website 4 is a part of a public website 5 on the Internet 6, which public website 5 comprises a web-shop where purchases can be made and where the personal website 4 also may contain personal quotations. A web-shop is a place which is accessible on the Internet 6 where a customer may perform purchases.

In still yet an embodiment of the system said website configuration system 3 has means (not shown) for sending means for accessing said personal website 4 to the customer. The means for accessing the personal website 4 is the information or the systems required for accessing the personal website 4 in a web browser system or other system for accessing web sites. Such information may be a web address, such as a URL to the personal website 4, log on information such as identity and password, or a computer program or other similar system, which may be used in order to access the personal website 4 from the public website 5. Means for accessing may be sent by e-mail, by Short Messaging Service (SMS), by Multimedia Messaging Service (MSM), or through printing means for accessing on a printer at the physical sales meeting premise, through sending means for accessing to a unit brought by the customer able to perform data communication, such as WLAN, Bluetooth, USB, Firewire, serial or parallel cable, IR or other similar data communication, or to allow the customer to define means for accessing, such as log on identity and password at the premises via a means for accessing input system (not shown), which may be arranged in the portable unit 7 with RFID reader 12 or in a separate system, as a computer or an information kiosk or other similar system at the physical sales meeting premise 2, or other similar means.

In a first usage example a customer arrives at a shop 2 and is met there by a salesperson. The customer and the salesperson walk around the shop together. The salesperson, in connection with the sales meeting, sweeps a portable unit 7 over different physical buttons 1, which are placed at the shop 2. As the customer is about to leave the salesperson offers the customer a personal website 4 with content from the meeting, which personal website 4 is easily accessible to the customer via the Internet 6. The customer accepts and the salesperson then activates the generation. The customer is given an id by the salesperson to bring home, which id may be used on the homepage of the shopping chain 5 in order to achieve access to the own personal website 4.

In a second usage example a customer arrives at a shop 2 and makes an own walk around. Using his/her mobile phone 7, which is equipped to read physical identifiers 1, the customer chooses certain physical identifiers 1, which are placed at different locations at the shop 2. The customer then leaves the shop 2 and after a while receives a message with a direct hyperlink to a personal website 4 at the homepage 5 of the shop.

The present invention also relates to a method for creating a personal website 4 in a public website 5 on the Internet 6. The method comprises the steps of: placing at least one RFID transponder 1 at a physical sales meeting premise 2; providing a website configuration system 3, with means 10 for creating the personal website 4 in the public website 5 on the Internet 6; providing at least one portable unit 7, comprising an RFID reader 12 and means 9 for wirelessly communicating data to the website configuration system 3; reading data from at least one RFID transponder 1 to at least one portable unit 7 via its RFID reader 12; where each portable unit 7 is arranged to send data, which have been read from at least one RFID transponder 1, to the website configuration system 3, which is arranged to create the personal website 4 in the public website 5 on the Internet 6 based on these data.

In a further embodiment the method comprises the steps of: placing multimedia units 8 at the physical sales meeting premise 2, which multimedia units 8 comprises means 11 for receiving to the website configuration system 3 wirelessly communicated data and means for presenting multimedia based on these data.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

1. A system for, during a visit at a physical sales meeting premise, creating a personal website in a public internet website clearly associated with the physical sales meeting premise, the system comprising:
at least one RFID transponder, intended to be placed at the physical sales meeting premise;
a website configuration system, having means for creating the personal website in the to the physical sales meeting premise clearly associated public website on the Internet; and
at least one portable unit, comprising an RFID reader and means for wirelessly communicating data to said web site configuration system;
where said at least one portable unit is arranged to send data, read via its RFID reader during the visit at the physical sales meeting premise from said at least one RFID transponder, to said web site configuration system, which is arranged to create said personal website in said to the physical sales meeting premise clearly associated public website on the Internet based on said data.

2. The system according to claim 1, further comprising:
multimedia units configured to be placed at said physical sales meeting premise, which multimedia units comprises means for receiving to said website configuration system wirelessly communicated data and means for presenting multimedia based on said data.

3. The system according to claim 1, wherein said at least one portable unit is a mobile phone, a handheld computer or laptop computer with a physically connected or an integrated RFID reader.

4. The system according to claim 1, wherein said personal website is part of a public website on the Internet, which public website includes a web-shop where purchases can be made and where said personal website may also contain personal quotations.

5. The system according to claim 1, wherein said website configurations system comprises means for sending access means for said personal website to a customer.

6. A method for, during a visit at a physical sales meeting premise, creating a personal website in a public internet website clearly associated with the physical sales meeting premise, the method comprising:
placing at least one RFID transponder at the physical sales meeting premise;
providing a website configurations system, having means for creating the personal website in the public website;
providing at least one portable unit, comprising an RFID reader and means for wirelessly communicating data to said website configuration system;
during the visit at the physical sales meeting premise reading data from said at least one RFID transponder to said at least one portable unit via its RFID reader;
where said at least one portable unit is arranged to send data, which has been read from said at least one RFID transponder, to said website configuration system, which is arranged to create said personal website in said to the physical sales meeting premise clearly associated public website on the Internet based on said data.

7. The method according to claim 6, further comprising:
placing multimedia units at said physical sales meeting premise, which multimedia units include means for receiving to said website configuration system wirelessly communicated data and means for presenting multimedia based on said data.
